(19) United States
(12) Patent Application Publication
(10) Pub. No.: US 2005/0121187 A1
(43) Pub. Date: Jun. 9, 2005

(54) Coolant system with regenerative heat exchanger

(75) Inventor: King Wai Chan, Chuluota, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/729,195

(22) Filed: Dec. 5, 2003

(51) Int. Cl. G05D 23/00

(52) U.S. Cl. 165/300

(57) ABSTRACT

In one embodiment the present invention provides for a system and method of transferring the heat of used coolant to source coolant by the use of a heat exchanger. A portion of the used coolant is passed through a regenerative heat exchanger where the heat from the used coolant is transferred to the source coolant. The amount of heat exchanged may be controlled by the amount of used coolant that is passed through the regenerative heat exchanger, where the remainder of the used coolant is discharged by conventional techniques.

### BACKGROUND OF THE INVENTION

There is a need in many different types of machinery to control the temperature of various components through cooling systems. Different machinery uses various techniques for cooling, one being the circulation of a cooling liquid. FIG. 1 illustrates one embodiment of this type of cooling system. A liquid source 2, such as water from a stream, river or tower, is piped 4 into a machine that requires cooling 8, such as a power generator. The water may cool the machine directly, by heat transfer through a pipe 10, which may include multiple passes past a heat source, or a separate cooling system 12, such as a gas system, may intertwine with the first cooling system to transfer heat more effectively. The heated liquid is passed out of the machinery 14 and disposed of.

A problem with this system is that the temperature of source water is usually controlled by the environment, such as a the seasonal temperature of a source stream or river. This requires that adjustments be made to the flow of the incoming water to keep the heat exchange constant, otherwise overcooling will result. Overcooling can cause the operating temperature of the machinery to drop below tolerances, resulting in problems such as moisture condensation and excessive thermal expansion/contraction. To prevent overcooling, the flow of the incoming water is reduced, thereby slowing the heat transfer.

Reducing flow, however, creates its own problems. A thin sediment film normally coats the inside walls of cooling water tubes when the flow rate is reduced below approximately one meter per second, due to slow and local stagnant flow zones with high chemical concentration will form at or near the tube wall. As the thickness of the film increases, corrosion and pinholes occur, resulting in leaks and increased fouling that interrupts effective heat transfer. This is particularly prevalent in the use of copper and copper alloy tubing, which is the preferred type of tubing due to its good heat exchange properties and low cost.

Another problem with this type of heat exchange system is that the heated water with much higher temperature than source water is usually discharged back into the source, such as a river. In large-scale systems, this is perceived to have short term destabilizing consequences to the local ecology.

One technique that sought to improve this problem is disclosed in U.S. Pat. No. 5,097,669, by Hargrove et al., which is included herein by reference. In the '669 patent, a portion of the heated water used in a hydrogen cooler is pumped back into the cooling water inlet. Depending upon the temperature of the cooling water, more or less heated water may be pumped in.

This technique, however, relies on the installation of a second pump to mix the heated water in with the cooling water; the cooling water being under pressure from being pumped from the source. Without the second pump pressurizing the heated water it would not mix with the higher pressure cooling water. Also, since this technique relies on the mixing of what is effectively used water with fresh, any particulate matter generated during the heat exchange cycle, gets put back into the mix. Though the amount of particulate matter in the used water of a hydrogen cooler may not be significant, other systems will be more sensitive to this type of recycling.

What is needed is a system and method for heating the source coolant so that a proper flow may be maintained without the disadvantages of recycling the used coolant.

### SUMMARY OF THE INVENTION

In one embodiment the present invention provides for a system and method of transferring the heat of a used coolant to a source coolant by the use of a heat exchanger. A portion of the used coolant is passed through a regenerative heat exchanger where the heat from the used coolant is transferred to the source coolant. The amount of heat exchanged may be controlled by the amount of used coolant that is passed through the regenerative heat exchanger, where the remainder of the used coolant is discharged by conventional techniques.

In one embodiment a single heat exchanger is used, and in a alternate embodiment a plurality of heat exchangers are used in series.

In one embodiment a portion of the source coolant flow is directed to at least one heat exchanger, and in a related embodiment a portion of the used coolant flow is directed to the same heat exchanger(s).

In another embodiment the portions of flow directed to the heat exchanger are controlled by three-way valves.

### BRIEF DESCRIPTION OF THE DRAWINGS

FIG. 1 illustrates a cooling system of the prior art.

FIG. 2 illustrates one example of a cooling system with a regenerative heat exchanger according to one embodiment of the present invention.

FIGS. 3-5 illustrate additional examples of cooling systems with regenerative heat exchangers according to various other embodiments of the present invention.

### DETAILED DESCRIPTION OF THE INVENTION

In one embodiment the present invention provides for a system and method of transferring the heat of used coolant to source coolant by the use of a heat exchanger. In many cooling systems, coolant, such as water, is taken from an environmental source, such as a lake or river. Since the temperature of the source coolant varies seasonally, the flow of the source coolant into the cooling system needs to be adjusted so that the cooling system maintains a consistent temperature. However, the flow rate of the coolant needs to be within a certain range and can neither be too fast nor too slow.

Typical to copper and copper alloy tube coolant systems, the flow rate needs to be maintained between about 3-10 feet per second (ft/s), about 1-3 meters per second, with variations between systems. At greater than about 10 ft/s the coolant can erode the tubes. At less than 3 ft/s the a thin sediment film may coat the inside walls of cooling tubes due to slow and local stagnant flow zones with increased chemical concentration will form at or near the tube wall. As the thickness of the film increases, corrosion and pinholes occur, resulting in leaks and increased fouling that interrupts effective heat transfer. However, in many environments, during winter source coolant, such as river water, is too cold to maintain a flow above 3 ft/s without overcooling adjoined machinery.

The present invention provides a system and method where a portion of the used coolant is passed through a regenerative heat exchanger where the heat from the used coolant is transferred to the source coolant. The amount of heat exchanged may be controlled by the amount of used coolant that is passed through the regenerative heat exchanger, where the remainder of the used coolant is handled by conventional techniques. As will be shown, various configurations may be used to control the amount of used coolant that is in heat exchange with the source coolant.

The present invention transfers heat from the used coolant to the source coolant without actually recycling a significant amount of the used coolant. The used coolant and source coolant are kept physically separate, though some small amount of leaking between the two may still occur without appreciably affecting the efficiency of the present invention. This is particularly useful in systems where the used coolant picks up particulates that are not desirable to have reentered back into the source coolant.

Since the used coolant has at least a portion of its heat transferred to the source coolant, any perceived environment impact from the cooling system is lessened. With the present invention, less heat is sent into the environment.

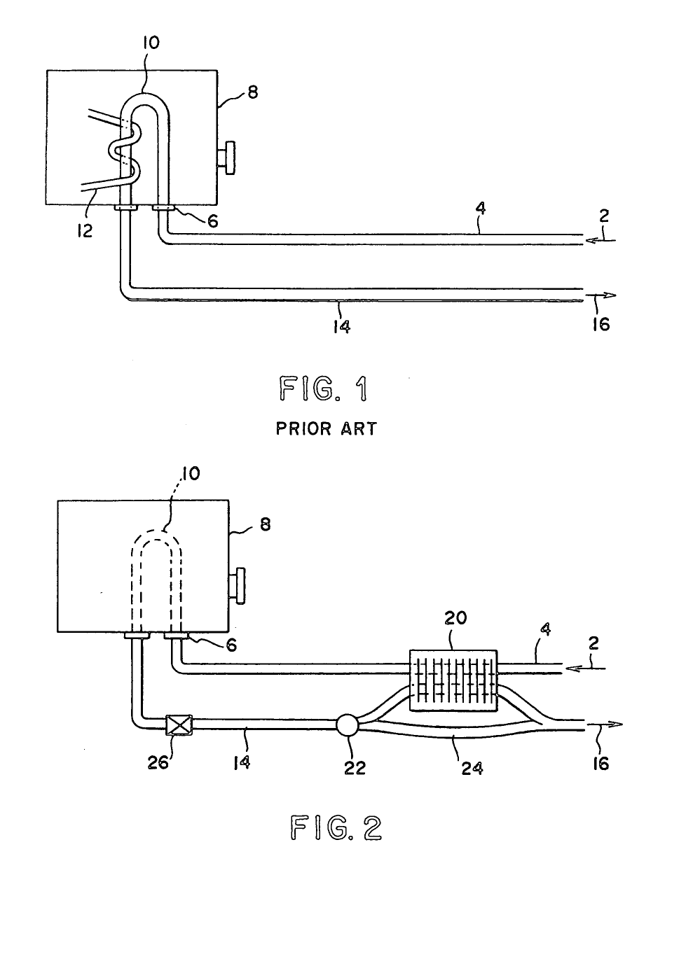

FIG. 2 illustrates one embodiment of the present invention. Source coolant 2, such as water from a lake or river, is pumped into a tubing system 4, and fed 6 into machinery 8 where it absorbs heat and is then fed back out 14 of the machinery and disposed of 16, such as reentering the environment downstream of the source intake. A regenerative heat exchanger 20 maintains thermal contact between the used coolant and the source coolant. As used herein, a regenerative heat exchanged, and heat exchanger, refers to any assembly that can continuously transfer heat from the used coolant to the source coolant without significant physical exchange between the two.

In this embodiment, a valve 22, such as a three-way valve is used to control the amount of used coolant flow diverted to the heat exchanger. By controlling the amount of used coolant flow through the heat exchanger, the amount of heat transferred to the source coolant may be controlled. Other mechanisms may be used to divert used coolant flow to the heat exchanger, such as a pump. Common to cooling systems are coolant flow valves 26. This may be used in conjunction with the controller for the amount of used coolant that enters the heat exchanger 20, or the two may also be combined into a single device.

In various embodiments, the set up may be flipped so that a portion of the source coolant is controlled and diverted into a heat exchanger rather than a portion of the used coolant. As will be discussed later, still another application is that the set up is mirrored for the source coolant, so that both the source coolant and the used coolant may be controlled in a similar fashion. Though this would increase the costs of the system, it would also increase the degrees of control an operator would have.

FIG. 3. illustrates an embodiment of the present invention where two regenerative heat exchangers are used in series. This configuration may be desirable, for example when the flow rate of the source coolant 2 cannot be sufficiently slowed to have the required amount of heat transferred from the used coolant flow 16. Other related embodiments include three or more heat exchangers set up in series or in parallel, where the divided flow 24 may be on the used coolant flow or on the source coolant flow or both.

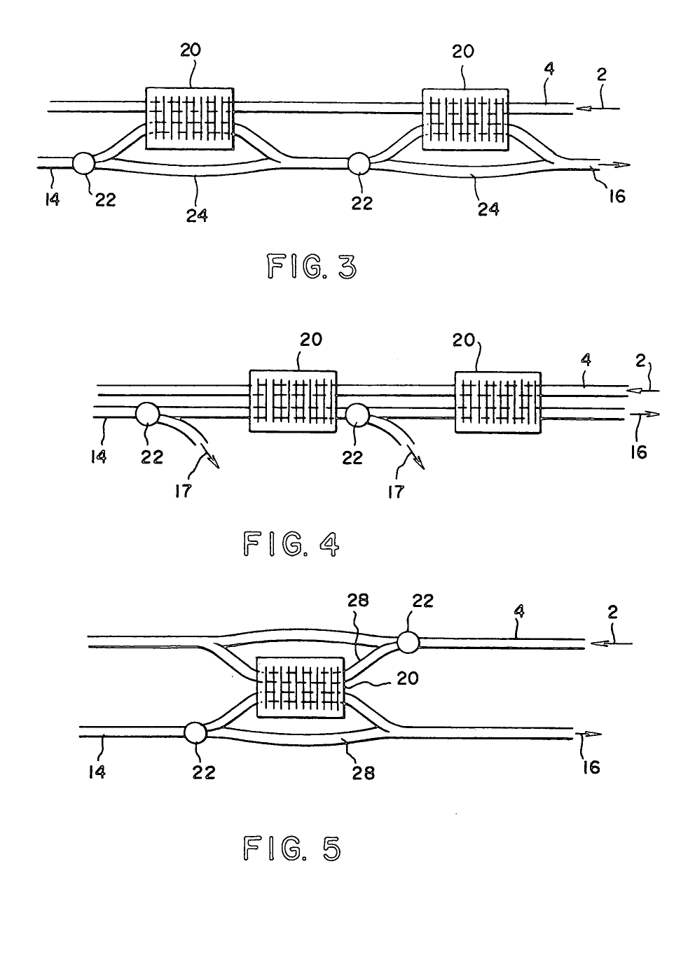

FIG. 4 illustrates still another example of the present invention, similar to that shown in FIGS. 2 and 3, but where the used coolant flow that is not directed to the heat exchangers 17 is sent to a different location. This other location may be a different application that needs heat, such as a heating system or another cooling system, or it may be a temporary reservoir where the used coolant can dissipate heat before being returned to the environment.

FIG. 5 illustrates the reversible nature of the present invention, in that the diverting of the coolant may be performed on either the source or used coolant or both. Since heat exchangers typically have reduced flow rates, it may be desirable to divert a portion 28 of the source coolant flow so that sufficient flow rates through the cooling system can be maintained. Though FIG. 5 shows a mirror imaged set-up, it is also an embodiment of the present invention where the methods for directing coolant flow into the heat exchanger(s) are different for the used and source flows.

In one embodiment, the present invention provides an apparatus for transferring heat from a used coolant flow to a source coolant flow. The apparatus comprises one or more regenerative heat exchangers, where some or all of the source coolant flow is passed through the heat exchanger. Similarly, some or all of the used coolant flow is also passed through the heat exchanger, though through different routing. The amount of flow that is diverted to the heat exchanger can be controlled by a variety of techniques, such as a three-way valve. The amount of flow, both source and used, that is directed to the heat exchanger is determined by the current versus desired temperature of the source coolant, as well as other factors such as optimal flow rate. Though heat from the used coolant flow is transferred to the source coolant flow, there is no substantial physical mixing between the two.

In one embodiment the used coolant flow is regulated by a flow control valve.

In one embodiment the amount of used coolant flow directed to the exchanger is controlled by a three-way valve. In a similar embodiment the portion of the source coolant flow that is passed through the heat exchanger is controlled by a three-way valve.

In another embodiment multiple heat exchangers are used.

In another embodiment the amount of the used coolant flow is separately directed through each of the plurality of heat exchangers. In a similar embodiment the amount of the source coolant flow is separately directed through each of the plurality of heat exchangers

In a particular embodiment the source coolant and the used coolant are water. In a related embodiment the source coolant is drawn from a natural source.

In one embodiment the present invention provides for a coolant system that comprises a source coolant drawing from a natural source and a source coolant channel, where the source coolant channel draws the source coolant to create a source coolant flow. Also, there is a regenerative heat exchanger that accepts at least a portion of the source coolant flow. The source coolant then flows through a machine assembly and cools the machine assembly. This produces a used coolant flow, a portion of which is directed into the regenerative heat exchanger. Heat from the used coolant flow is transferred to the portion of the source coolant flow in the heat exchanger and that portion of the source coolant flow is then merged back into the source coolant flow prior to entering the machine assembly.

In another embodiment of the present invention provides a method for transferring heat from a used coolant flow to a source coolant flow. The method comprises directing a portion of the source coolant flow to one or more heat exchangers and then routing a portion of the used coolant flow to the same heat exchanger(s). The heat from the used coolant flow is transferred to the source coolant flow, where the used coolant flow and the source coolant flow are not in substantial physical contact.

In a related method the used coolant flow is regulated by a flow control valve.

In a related method the amount of used coolant flow directed to the at least one heat exchanger is controlled by a three-way valve. In a similar method the portion of the source coolant flow that is passed through the heat exchanger is controlled by a three-way valve.

In another related method multiple heat exchangers are used.

In another method the amount of the used coolant flow is separately directed through each of the plurality of heat exchangers. In a similar method the amount of the source coolant flow is separately directed through each of the plurality of heat exchangers

In a particular related method the source coolant and the used coolant are water. In a related method the source coolant is drawn for a natural source.

Heat exchangers that may be used with this invention include products supplied by API Heat Transfer and GEA. Flow capacity for these types of heat exchangers can vary, but typically are in the range of 50 to 10,000 gallons (220-45,000 liters) per minute.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

1. An apparatus for transferring heat from a used coolant flow to a source coolant flow comprising:
at least one regenerative heat exchanger, wherein at least a portion of said source coolant flow is passed through said heat exchanger; and
a valve to direct a portion of said used coolant flow to said at least one regenerative heat exchanger;
wherein the amount of used coolant flow directed to said at least one heat exchanger is determined by the temperature of said source coolant flow;
wherein heat in said used coolant flow is transferred to said source coolant flow;
wherein said used coolant flow and said source coolant flow are not substantially in physical contact.

2. The apparatus of claim 1, wherein flow rate of said used coolant flow is controlled by a flow control valve.

3. The apparatus of claim 1, wherein the amount of used coolant flow directed to said at least one heat exchanger is controlled by a three-way valve.

4. The apparatus of claim 1, wherein the portion of said source coolant flow that is passed through said heat exchanger is controlled by a three-way valve.

5. The apparatus of claim 1, wherein said at least one heat exchanger comprises a plurality of heat exchangers.

6. The apparatus of claim 5, wherein an amount of said used coolant flow is separately directed trough each of said plurality of heat exchangers.

7. The apparatus of claim 5, wherein an amount of said source coolant flow is separately directed trough each of said plurality of heat exchangers.

8. The apparatus of claim 1, wherein said source coolant and said used coolant are water.

9. The apparatus of claim 8, wherein said source coolant is drawn for a natural source.

10. A coolant system comprising:
a source coolant drawing from a natural source;
a source coolant channel, wherein said source coolant channel draws said source coolant to create a source coolant flow;
a machine assembly, wherein said source coolant flows through a first heat exchanger in said machine assembly and cools said machine assemble, wherein a used coolant flow is produced; and
a regenerative heat exchanger that accepts at least a portion of said source coolant flow, and wherein at least a portion of said used coolant flow is direct into said regenerative heat exchanger;
wherein the heat of said used coolant flow is greater than the heat of said source coolant flow;
wherein heat from said used coolant flow is transferred to said portion of said source coolant flow;
wherein said portion of said source coolant flow is then merged back into said source coolant flow prior to entering said machine assembly.

11. A method for transferring heat from a used coolant flow to a source coolant flow comprising:
directing a portion of said source coolant flow to at least one heat exchanger; and
routing a portion of said used coolant flow to said at least one heat exchanger;
wherein heat from said used coolant flow is transferred to said source coolant flow;
wherein said used coolant flow and said source coolant flow are not substantially in physical contact.

12. The method of claim 1, wherein the flow of said used coolant flow is controlled by a flow control valve.

13. The method of claim 1, wherein the amount of used coolant flow directed to said at least one heat exchanger is controlled by a three-way valve.

14. The method of claim 1, wherein the portion of said source coolant flow that is passed through said heat exchanger is controlled by a three-way valve.

15. The method of claim 1, wherein said at least one heat exchanger comprises a plurality of heat exchangers.

16. The method of claim 15, wherein an amount of said used coolant flow is separately directed trough each of said plurality of heat exchangers.

17. The method of claim 15, wherein an amount of said source coolant flow is separately directed trough each of said plurality of heat exchangers.

18. The method of claim 1, wherein said source coolant and said used coolant are water.

19. The method of claim 18, wherein said source coolant is drawn for a natural source.
